(19) United States
(12) Patent Application Publication
(10) Pub. No.: US 2024/0357643 A1
(43) Pub. Date: Oct. 24, 2024

(54) A METHOD AND APPARATUS FOR DETERMINING SIDELINK RESOURCE

(71) Applicant: Samsung Electronics Co., Ltd., Suwon-si, Gyeonggi-do (KR)

(72) Inventors: Miao ZHOU, Beijing (CN); Yi WANG, Beijing (CN); Feifei SUN, Beijing (CN)

(21) Appl. No.: 18/683,762

(22) PCT Filed: Aug. 16, 2022
(86) PCT No.: PCT/KR2022/012168

§ 371 Date: Feb. 14, 2024

(30) Foreign Application Priority Data
Aug. 16, 2021 (CN) 202110939142.4

(51) Int. Cl. H04W 74/0808; H04W 92/18

(52) U.S. Cl. CPC H04W 74/0808; H04W 92/18

(57) ABSTRACT

The disclosure relates to a 5G or 6G communication system for supporting a higher data transmission rate. The application discloses a method for determining sidelink resource, the method comprising: applying a sidelink communication system on a shared spectrum by a first node; and determining a sidelink transmission resource based on the sidelink communication system being applied on the shared spectrum.

### TECHNICAL FIELD

The present application relates to the field of wireless communication technology, and more specifically, to a method and device for sidelink communication in the wireless communication in the fifth-generation new radio access technology (5G NR) system, including determining resource structure, resource location and the transmission mode.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), Al service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, Al-based communication technology for implementing system optimization by utilizing satellites and AI (Artificial Intelligence) from the design stage and internalizing end-to-end Al support functions, and next-generation distributed computing technology for implementing services at levels of complexity exceeding the limit of UE operation capability by utilizing ultra-high-performance communication and computing resources.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### DISCLOSURE OF INVENTION

### Solution to Problem

The aspects and advantages of the embodiments of the present disclosure will be partially described in the following description, or can be learned from the description, or can be learned through the implementation of the embodiments.

The application provides a method for applying a sidelink communication system to the shared spectrum (also known as unlicensed frequency band), so that the sidelink communication can be applied in a wider spectrum and a larger bandwidth. The method is beneficial to improve the performance such as throughput, reliability, latency and the like of the sidelink communication, thereby expanding the application scenarios of the sidelink communication.

Specifically, the application provides a method for determining sidelink resources, the method comprising: applying a sidelink communication system on a shared spectrum by a first node; and determining a sidelink transmission resource based on the sidelink communication system being applied on the shared spectrum.

The above and other features, aspects and advantages of various embodiments of the present disclosure will be better understood with reference to the following description and the appended claims. The accompanying drawings of the specification constituting a part of the present disclosure illustrate example embodiments of the present disclosure and are used together with the description to explain relevant principles. The details of one or more implementations on the subject of the present invention are set forth in the accompanying drawings of the specification and the following description. Through these descriptions, drawings and claims, other potential features, aspects and advantages of the subject matter of the invention will also become clear.

### Advantageous Effects of Invention

According to an embodiment of the present invention the sidelink communication can be applied in a wider spectrum and a larger bandwidth.

### BRIEF DESCRIPTION OF DRAWINGS

FIG. 1 illustrates a wireless network 100 according to various embodiments of the present disclosure;

FIG. 2A illustrates a wireless transmission and reception path according to various embodiments of the present disclosure;

FIG. 2B illustrates a wireless transmission and reception path according to various embodiments of the present disclosure;

FIG. 3A illustrates a UE according to various embodiments of the present disclosure;

FIG. 3B illustrates a gNB according to various embodiments of the present disclosure;

FIG. 4 is a flowchart showing a method according to an example embodiment of the present disclosure;

FIG. 5 schematically illustrates an embodiment according to the present disclosure;

FIG. 6A schematically illustrates an embodiment according to the present disclosure.

FIG. 6B schematically illustrates an embodiment according to the present disclosure.

FIG. 7 schematically illustrates an embodiment according to the present disclosure.

FIG. 8 schematically illustrates a base station according to various embodiments of the present disclosure; and

FIG. 9 schematically illustrates a UE according to various embodiments of the present disclosure.

### BEST MODE FOR CARRYING OUT THE INVENTION

A method for determining sidelink resource is provided. The method includes applying a sidelink communication system on a shared spectrum by a first node and determining a sidelink transmission resource based on the sidelink communication system being applied on the shared spectrum.

In an embodiment, applying of the sidelink communication system on the shared spectrum by the first node may include determining a relevant information of the sidelink resources in channel occupation time COT and/or a relevant information of the sidelink resources in a sidelink burst by the first node.

In an embodiment, determining of the relevant information of the sidelink resources in the channel occupation time and/or the relevant information of the sidelink resources in the sidelink burst by the first node may include determining at least one of the number, length and position of the gap in the COT and/or at least one of the number, length and position of the gap in the sidelink burst by the first node.

In an embodiment, the first node may determine at least one of the number, length and position of the gap in the COT and/or at least one of the number, length and position of the gap in the sidelink burst through pre-configured and/or base station-configured and/or other node-configured information and/or predetermined criteria.

In an embodiment, at least one of followings may be include in the sidelink burst: one or multiple sidelink control resources, one or multiple sidelink data resources, or one or multiple sidelink feedback resources.

In an embodiment, different resources in the sidelink burst may be used by the first node to transmit signals/channels to different or same sidelink node.

In an embodiment, determining of the sidelink transmission resource by the first node may include determining the used sidelink burst by the first node and determining to perform sidelink transmission in the sidelink burst.

In an embodiment, determining to perform sidelink transmission in the sidelink burst by the first node may include determining that all control and/or data resources in the sidelink burst can be used by the first node for transmission of control channels and/or data channels after determining the used sidelink burst.

In an embodiment, determining to perform sidelink transmission in the sidelink burst by the first node may include performing transmission through at least one of the first node transmits a physical sidelink control channel PSCCH on a sidelink control resource, the first node transmits a 2-stage sidelink control information SCI on a sidelink data resource, the first node transmits a physical sidelink shared channel PSSCH to the same node on one or multiple sidelink data resources and the first node transmits PSSCH to different nodes on multiple sidelink data resources.

In an embodiment, when transmitting the PSSCH to the same node on one or multiple sidelink data resources by the first node, the PSCCH or the 1-stage SCI and/or the 2-stage SCI in the sidelink burst may indicate the destination identity ID of the same node and/or indicate the sidelink data resources relevant information used for sidelink transmission in the sidelink burst.

In an embodiment, when transmitting the PSSCH to different nodes on multiple sidelink data resources by the first node, the PSCCH or the 1-stage SCI and/or the 2-stage SCI within the sidelink burst may indicate the destination ID of the different nodes, or indicate the sidelink data resource relevant information used for sidelink transmission and/or the correspondence between the sidelink data resources and the destination ID of the nodes in the sidelink burst.

In an embodiment, determining of the sidelink transmission resources by the first node may include determining to use at least one of the followings for HARQ-ACK feedback using HARQ-ACK feedback bundling, using sidelink codebook based HARQ-ACK feedback, or using independent HARQ-ACK feedback.

In an embodiment, determining of which way to use for HARQ-ACK feedback may be based on the configuration and/or the number of PSFCH resources.

In an embodiment, determining to perform sidelink transmission in the sidelink burst by the first node may include at least one of if the first node transmits a physical sidelink shared channel PSSCH to the same node on a plurality of continuous sidelink data resources, a physical sidelink control channel PSCCH is transmitted on a sidelink control resource corresponding to the first sidelink data resource in the plurality of continuous sidelink data resources, or if the first node transmits PSSCH to the same node on a plurality of continuous sidelink data resources, a 2-stage sidelink control information SCI is transmitted on the first sidelink data resource of the plurality of continuous sidelink data resources, and the 2-stage SCI indicates the control information of PSSCH on the plurality of continuous sidelink data resources. The PSCCH may indicate the number of the plurality of continuous sidelink data resources.

In an embodiment, determining to perform sidelink transmission in the sidelink burst by the first node may included if the first node uses M consecutive sidelink data resources to transmit data to the same or different destination nodes, and the first node uses the same transmission power on the M sidelink data resources, the first sidelink data resource and/or the associated sidelink control resources of the M consecutive sidelink data resources are mapped from the second time unit, and the remaining sidelink data resources and/or the associated sidelink control resources of the M consecutive sidelink data resources are mapped from the first time unit, wherein the first time unit of the first sidelink data resource and/or the associated sidelink control resources can be used for automatic gain control AGC.

In an embodiment, determining to perform sidelink transmission in the sidelink burst by the first node may include at least one of if the first node uses M consecutive sidelink data resources and/or corresponding sidelink control resources to transmit the physical sidelink shared channel PSSCH and/or the associated physical sidelink control channel PSCCH to the same or different destination nodes, the first node transmits the PSSCH and/or the associated PSCCH with the same transmission power, if the first node uses M consecutive sidelink data resources and/or corresponding sidelink control resources to transmit PSSCH and/or associated PSCCH to the same or different destination nodes, the first node determines the transmission power of PSSCH and/or associated PSCCH based on the downlink loss, or if the transmitting node indicates in SCI that M consecutive sidelink data resources and/or corresponding sidelink control resources are used to transmit PSSCH and/or associated PSCCH, it is indicated in SCI whether the transmission powers of the M PSSCH and/or the associated PSCCH are the same. The sidelink control resources may include PSCCH resources, and the sidelink data resources comprise PSSCH resources.

In an embodiment, determining the sidelink transmission resources by the first node may include determining candidate sidelink resource set located in the sidelink burst by the first node based on sensing, determining whether there are unavailable resources in the candidate sidelink resource set and/or whether there are preferentially selected resources based on the transmission status in the sidelink burst and selecting resources for sidelink transmission accordingly.

In an embodiment, determining whether there are unavailable resources in the candidate sidelink resource set may include when no signal is detected within a time range exceeding a specific length before the candidate resource, it is determined that the candidate resource is unavailable and/or that other resources later than the candidate resource are unavailable.

In an embodiment, determining whether there are preferentially selected resources in the candidate sidelink resource set may include when the adjacent sidelink resource prior to the candidate resource is reserved by other sidelink transmission and/or a signal is detected on the adjacent sidelink resource prior to the candidate resource, the candidate resource is preferentially selected for sidelink transmission.

A first node device is provided. The first node device includes a transceiver and a controller coupled with the transceiver and configured to apply a sidelink communication system on a shared spectrum by a first node and determine a sidelink transmission resource based on the sidelink communication system being applied on the shared spectrum.

### Mode for the Invention

Before undertaking the description below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions of certain words and terms are given in the description of the present disclosure. Those of ordinary skill in the art should understand that, in many cases (if not in most cases), such definitions are applicable to the use of such defined words and terms in various situations in the past and in the future. Unless otherwise specified, the terms used in the present disclosure have the same meanings as understood by those of ordinary skill in the art to which the present disclosure belongs. For example, the terms of those terms defined in commonly used dictionaries should be interpreted as having the same meaning as the context in the relevant field, and should not be interpreted as having a transitional idealized or formalized meaning.

Although terms including ordinal numbers such as “first” and “second” are used to describe various elements (for example, components, steps, etc.), these elements are not limited by these terms. These terms are only used to distinguish one element from another. Therefore, these terms may be used interchangeably without departing from the scope of the present disclosure. For example, the first element may be referred to as the second element, and similarly, the second element may also be referred to as the first element. In addition, as used herein, the terms “/”, “or”, “and/or” are intended to include any and all combinations of one or more related items.

By referring to the following detailed description of the various embodiments and the accompanying drawings in the specification, the aspects and features of the present disclosure and the implementation thereof can be understood more clearly. However, the present disclosure may be embodied in many different forms, and should not be construed as being limited to the various embodiments set forth herein. Rather, these embodiments are provided to make the present disclosure full and complete, and to fully convey the principles and concepts of the present disclosure to those skilled in the art. Therefore, those of ordinary skill in the art should recognize that various modifications, adjustments, combinations and substitutions can be made to the various embodiments described in the present disclosure without departing from the spirit and scope of the present disclosure. Moreover, these modifications, adjustments, combinations and substitutions should also be considered to be included in the scope of protection of this application as defined by the claims.

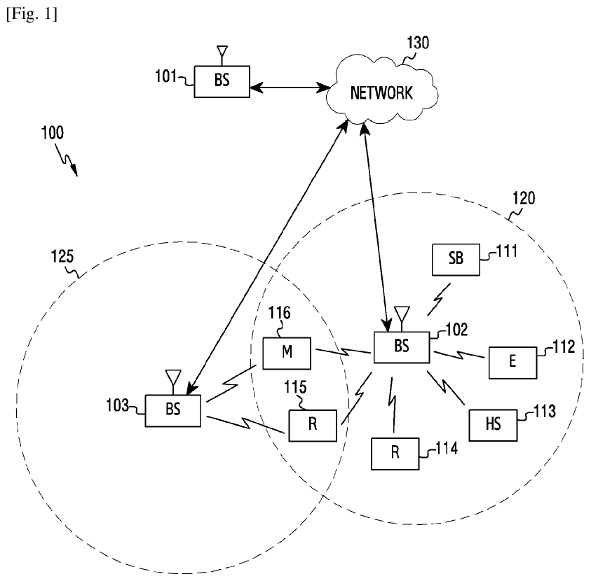

FIG. 1 illustrates a wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

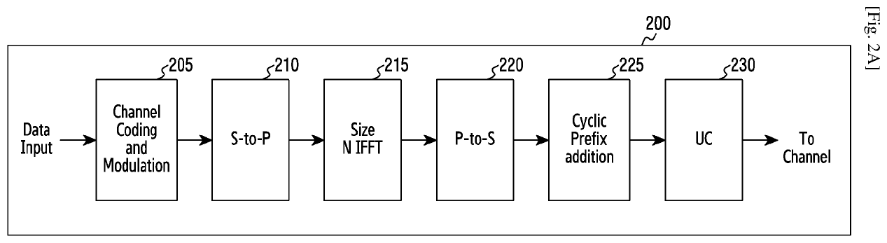

FIGS. 2A and 2B illustrates a wireless transmission and reception path according to various embodiments of the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrates a wireless transmission and reception path according to various embodiments of the present disclosure, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

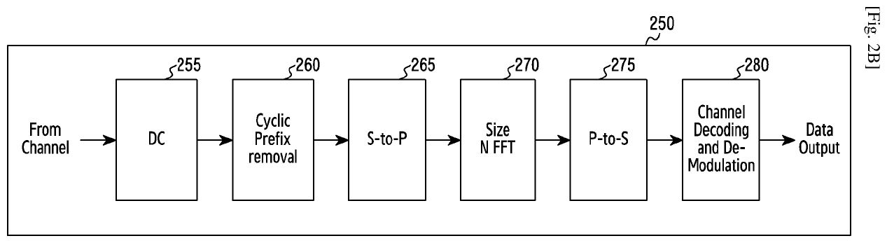

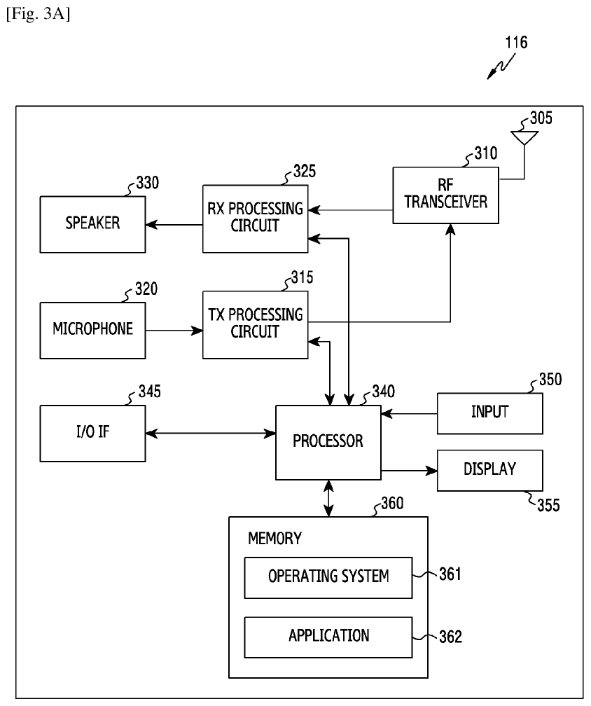

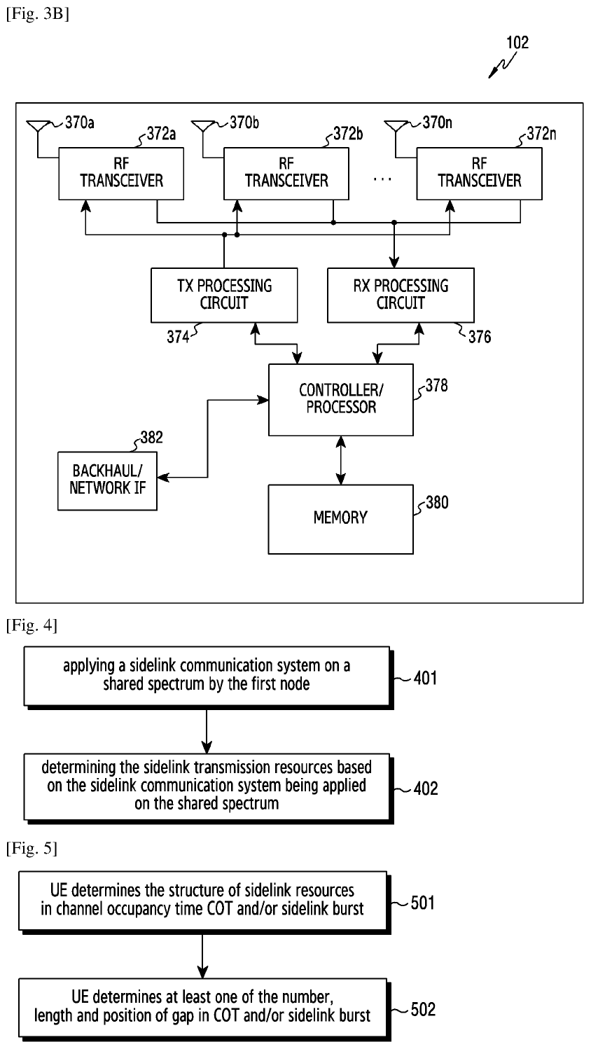

FIG. 3A illustrates a UE according to various embodiments of the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or multiple applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or multiple processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates illustrates a UE according to various embodiments of the present disclosure, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or multiple central processing units (CPUs) and one or multiple graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates a gNB according to various embodiments of the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or multiple processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In long term evolution (LTE) technology, the sidelink communication includes two main mechanisms: Device to Device (D2D) direct communication and Vehicle to Vehicle/Infrastructure/Pedestrian/Network (collectively referred to as V2X), wherein V2X is designed on the basis of D2D technology. It is superior to D2D in terms of data rate, latency, reliability, link capacity, etc., and is the most representative sidelink communication technology in LTE technology.

5G NR system, as the evolution technology of LTE, also includes the further evolution of sidelink communication accordingly, establishes NR V2X technology in Version 16. As the evolution version of LTE V2X technology, NR V2X has superior performance in all aspects. In version 17, the 5G NR system is expected to further expand the application scenarios of NR V2X to other broader application scenarios, such as commercial sidelink communication and Public Safety (PS) scenarios.

In the sidelink communication systems of LTE and NR, the sidelink communication system is designed mainly on the basis of the requirements of specific D2D and vehicle commercial scenarios, its used frequency bands are mainly concentrated in specific licensed frequency bands, such as the ITS frequency band dedicated to vehicle traffic, etc. With the development of 5G technology, the commercial model of sidelink communication is growing day by day, so it is necessary to enhance the sidelink communication technology so that it can be applied to wider application scenarios, such as XR, IIoT, RedCap, etc. For the business requirements of some future application scenarios, the transmission rate, latency and reliability that the current sidelink communication technology can achieve need to be further enhanced. A feasible method is to apply the sidelink communication to more frequency bands, such as unlicensed frequency bands, to increase the transmission rate and reliability that the sidelink system can support by increasing the bandwidth, and to reduce the service transmission delay through high-frequency communication. However, the current sidelink communication system has not discussed the possibility of sidelink communication in unlicensed frequency bands, and has not introduced any enhancement mechanism for unlicensed frequency bands.

The exemplary embodiments of the present disclosure are further described below with reference to the accompanying drawings.

The text and the accompanying drawings are provided only as examples to help readers understand the present disclosure. They are not intended and should not be construed as limiting the scope of the present disclosure in any way. Although some embodiments and examples have been provided, based on the contents disclosed herein, it is obvious to those skilled in the art that the embodiments and examples shown can be modified without departing from the scope of the present disclosure.

NR V2X system defines several sidelink physical channels, including Physical Sidelink Control Channel (PSCCH), Physical Sidelink Shared Channel (PSSCH) and Physical Sidelink Feedback Channel (PSFCH). PSSCH is used to carry the data, PSCCH is used to carry Sidelink control information (SCI), the SCI indicates the time-frequency domain resource position of the associated PSSCH transmission, modulation and coding mode, receiving destination ID for PSSCH and other information, and PSFCH is used to carry HARQ-ACK information corresponding to the data.

From the perspective of resource allocation, 5G sidelink communication system includes two modes: a resource allocation mode based on base station scheduling and a resource allocation mode independently selected by UE. In 5G V2X system, the resource allocation mode based on base station scheduling is referred to as mode 1; the resource allocation mode independently selected by UE is referred to as mode 2.

For mode 1, the method for the base station to schedule resource for the sidelink UE is to transmit a sidelink grant to the sidelink UE, and several or periodic sidelink resources used for the sidelink UE are indicated in the sidelink grant. The sidelink grant includes dynamic grant and configured grant, wherein the dynamic grant is indicated by DCI, the configured grant further includes the configured grant of type 1 and type 2, the configured grant of type 1 is indicated by RRC signaling, and the configured grant of type 2 is indicated by RRC signaling and activated/deactivated by DCI.

For mode 2, the method for the sidelink UE to independently select resource is that the UE determines a specific time window before the sidelink transmission according to the expected time range of transmitting the sidelink transmission, and the UE performs channel sensing in the specific time window, then excludes the sidelink resources that have been reserved by other sidelink UE according to the result of channel sensing, and randomly selects from the sidelink resources which are not excluded.

The current NR V2X system takes slots in the 5G system as the minimum unit of time domain resource allocation, and defines Sub-Channels as the minimum unit of frequency domain resource allocation, wherein one Sub-Channels is configured as several Resource Block (RB) in the frequency domain, and one Sub-Channels may include resources corresponding to at least one of PSCCH, PSSCH and PSFCH.

The slot in the embodiment of the application can be either a subframe or slot in the physical sense or a subframe or slot in the logical sense. Specifically, the subframe or slot in the logical sense is the subframe or slot corresponding to the resource pool of sidelink communication. For example, in V2X system, the resource pool is defined by a repeated bitmap, which is mapped to a specific set of slots. The specific set of slots can be all slots or all other slots except some specific slots (such as the slot for transmitting MIB/SIB). The slot indicated as “1” in the bitmap can be used for V2X transmission and belongs to the slot corresponding to V2X resource pool; the slot indicated as “0” cannot be used for V2X transmission and does not belong to the slot corresponding to the V2X resource pool.

The following is a typical application scenario to illustrate the difference between the physical or logical subframes or slots: when calculating the time domain gap between two specific channels/messages (such as PSSCH carrying sidelink data and PSFCH carrying corresponding feedback information), it is assumed that the gap is N slots. If the physical subframe or slot is calculated, the N slots correspond to the absolute time length of N*x milliseconds in the time domain, x is the time length of the physical slot (subframe) under the numerology of the scenario in millisecond; otherwise, if the subframe or slot in the logical sense is calculated, take the sidelink resource pool defined by the bitmap as an example, the gap of the N slots corresponds to the N slots indicated as “1” in the bitmap, and the absolute time length of the gap changes with the specific configuration of the sidelink communication resource pool without a fixed value.

Further, the slot in the embodiment of the present application can be a complete slot or several symbols corresponding to the sidelink communication in one slot. For example, when the sidelink communication is configured to be performed on the X1-X2 symbols of each slot, the slot in the following embodiment is the X1-X2 symbols in the slot in this scenario; alternatively, when the sidelink communication is configured as mini slot transmission, the slot in the following embodiment is a mini slot defined or configured in the sidelink system rather than a slot in the NR system; alternatively, when the sidelink communication is configured as symbol level transmission, the slot in the following embodiment may be replaced with a symbol, or may be replaced with N symbols of time domain granularity as symbol level transmission.

In the embodiment of this application, the information configured by the base station, indicated by the signaling, configured by the higher layer, and pre-configured includes a group of configuration information; it also includes multiple groups of configuration information, and the UE selects a group of configuration information for use according to predefined conditions; it also includes a group of configuration information including multiple subsets, from which UE selects a subset for use according to predefined conditions.

Some of the technical solutions provided in the embodiments of the application are specifically described based on V2X system, but the application scenario thereof should not be limited to V2X system in the sidelink communication, but can also be applied to other sidelink transmission systems. For example, the design based on the V2X subchannel in the following embodiments can also be used for D2D subchannel or other sidelink transmission subchannel. The V2X resource pool in the following embodiments can also be replaced with a D2D resource pool in other sidelink transmission systems, such as D2D.

In the embodiment of the application, when the sidelink communication system is V2X system, the terminal or UE can be various types of terminals or UEs such as Vehicle, Infrastructure, Pedestrian, etc.

In order to make the objectives, technical solutions, and advantages of the present application clearer, the implementation of the present application will be further described in detail below in conjunction with the accompanying drawings.

In the embodiment of the present application, lower than the threshold can also be replaced by at least one of higher than the threshold, lower than or equal to the threshold and higher than or equal to the threshold; higher than (exceeding) the threshold may also be replaced by at least one of lower than the threshold, lower than or equal to the threshold, and higher than or equal to the threshold. Lower than or equal to may also be replaced by at least one of lower than, higher than, higher than or equal to, or equal to; higher than or equal to may also be replaced with at least one of lower than, higher than, lower than or equal to, or equal to.

In the traditional communication system, Since the DRX system mainly corresponds to PDCCH reception, it is called discontinuous reception. In the sidelink communication system, DRX mechanism can be used for the transmission and reception of UE. Correspondingly, in the embodiment of the application, DTX (discontinuous transmission) and DRX (discontinuous reception) can be replaced with each other, and the protection scope should not be affected by the different names.

The base station in this specification can also be replaced by other nodes, such as sidelink nodes. A specific example is the infrastructure UE in the sidelink system. Any mechanism applicable to the base station in this embodiment can also be similarly used in the scenario where the base station is replaced with other sidelink node, and the description is not repeated.

In this specification, the active period/inactive period of DRX configuration and the measurement window of measurement may include physical subframes and/or logical subframes, wherein the logical subframes include subframes configured for the sidelink resource pool.

FIG. 4 is a flowchart showing a method according to an example embodiment of the present disclosure, which includes the following steps:
Step 401: applying a sidelink communication system on the shared spectrum by the first node;
Step 402: determining the sidelink transmission resources based on the sidelink communication system being applied on the shared spectrum.

FIG. 5 schematically illustrates an embodiment according to the present disclosure.

In LTE sidelink communication system and NR V2X system of version 16, the frequency domain resources for sidelink communication are usually located in the licensed frequency band. Generally, it is assumed that there is basically no interference from other external communication systems (such as WiFi, Bluetooth, etc.) in the frequency band. However, for the sidelink communication system operating in the unlicensed frequency band, it is necessary to consider the interference of other communication systems on the unlicensed carrier, and it is also necessary to limit the interference of sidelink communication on other communication systems according to regulation.

In NR unlicensed (NR-U) systems of versions 15 and 16, listen before talk (LBT) is adopted as one of the typical technologies in the unlicensed frequency band. In the technology, a special frame structure is defined for NR communication system in the unlicensed frequency band, which contains several gaps for LBT. The UE and the base station need to perform LBT before uplink and downlink transmission, and can transmit various kinds of wireless signals/channels normally only after the LBT passes. The embodiment provides a method of applying the LBT technology to sidelink communication system.

In the communication system in the unlicensed frequency band, channel occupancy (CO) refers to the transmission on the corresponding channel after the base station/UE performs the channel access procedure, and channel occupancy time (COT) refers to the total transmission time on the corresponding channel after the base station/UE and the base station/UE sharing the channel occupancy perform the channel access procedure. Both the base station and/or the sidelink UE can initialize a COT and share the COT with other base stations and/or the sidelink UE. After the UE initializes a COT or acquires the COT shared by the base station/other nodes, it is necessary to determine the structure and location of sidelink resources in the COT. In the embodiment, the specific method for UE to determine the structure and location of sidelink resources in COT will be described.

In the existing techniques, the structure of uplink/downlink resources in COT can be embodied by uplink/downlink burst, wherein the uplink/downlink burst is a transmission set from a base station or UE, and there is no gap exceeding a specific length between them. Similar to the definition of uplink/downlink burst in the existing techniques, the structure of sidelink resources in COT can also be embodied by sidelink burst, wherein the sidelink burst is a transmission set from UE, and there is no gap exceeding a specific length (for example, 16 us) between them. Alternatively, only the transmissions from the same UE are included in one burst; or, transmissions from the same or different UEs can be included in one burst. Alternatively, only one or multiple specific signals/channels are included in a burst; for example, only PSCCH and/or PSSCH are included in one burst, only PSFCH is included in another burst, or PSCCH, PSSCH and PSFCH can be included in one burst. Alternatively, similar to the discovery burst in the existing techniques, the sidelink synchronization signal, the sidelink synchronization channel and the sidelink reference signal (which can be a reference signal of a specific type/a reference signal satisfying a specific condition) correspond to the sidelink discovery burst instead of the common sidelink burst.

The UE determining the structure of sidelink resources in COT includes determining at least one of the start position of time domain resources, the end position of time domain resources, the length of time domain resources, the start position of frequency domain resources, the end position of frequency domain resources and the length of frequency domain resources corresponding to COT, and can also include determining at least one of the above parameters corresponding to sidelink burst (and/or sidelink discovery burst, which are similar below and will not be repeated in the specification).

As shown in FIG. 5, the UE determines relevant information (e.g., structure) of sidelink resources in COT and/or relevant information of sidelink resources in sidelink burst (501), it also includes that the UE determines at least one of the number, length and position of gap in COT and/or at least one of the number, length and position of gap in sidelink burst (502). Wherein the gap can be used by the UE for LBT to sense the availability of the channel. Further, the UE determines at least one of the number, length and position of gap in COT and/or at least one of the number, length and position of gap in sidelink burst through preconfigured and/or base station configured and/or other node configured information and/or predetermined criteria.

In some embodiments, the UE obtains the information related to the gap indicated by the at least one configuration above, and determines at least one of the number, length and location of the gap accordingly. The information can be explicitly indicated, for example, the UE obtains at least one of the number, length and location of the gap indicated by fields in RRC signaling from the base station.

In some embodiments, the UE determines at least one of the number, length and location of the gap accordingly according to predefined criteria and information related to the gap indicated by the at least one configuration above. Further, the UE determines that each sidelink burst is preceded by a specific gap of one or multiple lengths according to a predetermined criteria, and determines at least one of the number, length and position of sidelink burst and/or gap according to the acquired information related to sidelink burst indicated by the at least one configuration above. In a specific example, the UE determines the length of gap according to predetermined criteria, obtains the number and/or length of sidelink burst indicated by the base station in RRC signaling, and determines the position of each sidelink burst, the number and position of gap accordingly. In another specific example, there are several candidate positions that may be used as gap in a COT of a specific length, and the UE obtains the information about which candidate positions are actually used as gaps, as indicated by the base station in RRC/MAC (Media Access Control)/DCI.

In some embodiments, the starting position of each sidelink burs is a gap, and the gap is followed by one or multiple slots, wherein the length of the one or multiple slots is determined based on the length of gap on the basis of the existing techniques, including the length based on puncture and the length based on rate matching. In a specific example, if the length of gap in the sidelink burst is denoted as n us and the number of slots is denoted as x, the length of the first slot of the x slots is the length in the existing techniques (denoted as m us) minus n us. Specifically, the frame structure of the first slot is the slot frame structure in the existing techniques, which is truncated from the starting position by n us as a gap, and the rest remain unchanged; or the length of the first slot is m-n us, and its frame structure is a redefined frame structure. The length and frame structure of the remaining x-1 slots are the same as those in the existing techniques. In another specific example, the length of gap in the sidelink burst is denoted as n us, and the number of slots is denoted as x, and all of those x slots are m-n us in length, and their frame structures are a redefined frame structure. In the embodiment, the above frame structures include information such as the length, number and position of symbols in a slot, and may also include information such as the length and position of specific types of signals/channels (such as PSSCH/PSCCH/PSFCH/DMRS (Demodulation Reference Signal)) in a slot.

Since the adjacent (for example, in the same slot) data/control resources and feedback resources can be occupied by different UEs, there is usually one symbol between the data/control resources and the feedback resources as the handover gap. Similarly, in the existing techniques, one symbol at the end of each slot is also used as the handover gap. Since the sidelink burst requires that there is no gap exceeding a specific length (for example, 16 us) inside it, when the length of the next symbol in a specific SCS exceeds the specific length, the gap in the sidelink frame structure in the existing techniques will affect the structure of the sidelink burst. In some embodiments, in each sidelink burst, if the UE determines that the length of the at least one above mentioned gap exceeds a specific length, the UE adopts the above mentioned at least one gap of less than one symbol. In a specific example, the sidelink burst requires that there is no gap exceeding a specific length x us inside it. If the UE determines that the length of one symbol in the specific SCS is y us and y>x, the UE determines that the first part of symbols which does not exceed x us is the gaps and the rest is used for sidelink transmission/reception. For example, the other parts of the symbol used as the gap except the gap not exceeding x us can be regarded as Automatic Gain Control (AGC) symbols; for another example, the symbol used as a gap can be regarded as the repetition of another symbol (which can be another symbol adjacent to the symbol used as a gap), and the symbol used as a gap can be truncated by no more than x us from the starting position as a gap; for another example, the signal/channel rate can be matched to the symbol used as a gap, and the symbol used as a gap can be truncated by no more than x us from the starting position as agap; for another example, in addition to the first part of the symbols that does not exceed x us used as gap, the rest of the symbols can be used to transmit reference signals.

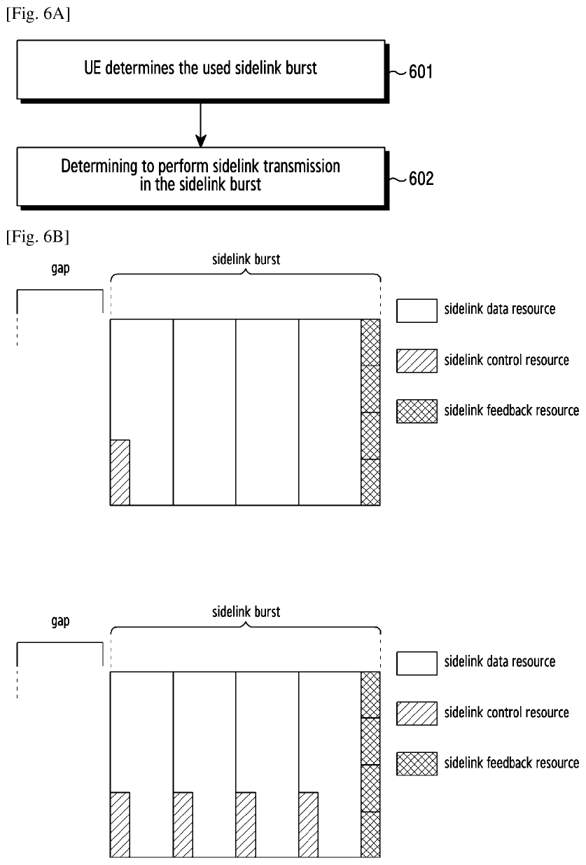

FIG. 6A schematically illustrates an embodiment according to the present disclosure.

The existing sidelink communication system uses slot-level resource allocation, and does not support symbol-level resource allocation and slot aggregation of multiple slots. When the sidelink communication system is deployed in the unlicensed frequency band, considering the requirement of LBT before transmission by regulations, the resource allocation method in the existing techniques may cause great waste of resources. In the embodiment, an enhanced sidelink resource allocation method is provided, which can effectively reduce the overhead of LBT, thereby improving the utilization efficiency of resources in the sidelink communication system.

As shown in FIG. 6, the UE determines the used sidelink burst (601), and then determines to perform sidelink transmission in the sidelink burst (602).

In some embodiments, one sidelink burst includes one sidelink control resource and a plurality of sidelink data resources, and may or may not include one or multiple sidelink feedback resources; the time domain length of each resource can be N slots and/or N symbols, where N is a positive integer, and different types of resources correspond to the same or different values of N. When the UE determines the sidelink transmission resources, after determining the used sidelink burst, it is considered that all control and/or data resources in the sidelink burst can be used by the UE for the transmission of control channels and/or data channels; further, different resources in the sidelink burst can be used by the UE for transmitting signals/channels to different or the same sidelink nodes.

In a specific example, UE1 determines to use the sidelink burst as shown in FIG. 6B for sidelink transmission. The sidelink burst contains one sidelink control resource (referred as PSCCH resource in the example), four sidelink data resources (referred as PSSCH resource in the example) and N sidelink feedback resources (referred as PSFCH resource in the example). Note that the number of PSSCH resources in the sidelink burst being four is only an example for the convenience of the following description, and can be similarly replaced with other values, which should not limit the protection scope. As shown in FIG. 6B, the one PSCCH resource and the first PSSCH resource are FDM and TDM (here is only an example, and it can also be frequency-division multiplexing (FDM) only or time-division multiplexing (TDM) only, which will not be shown additionally), the PSCCH and PSSCH resources and the PSFCH resource are TDM. In the example, since the sidelink communication uses the 2-stage SCI mechanism, PSCCH resources are used to transmit the 1-stage SCI, and PSSCH resources can be used to transmit the 2-stage SCI; specifically, the UE can transmit the 2-stage SCI on the first PSSCH resource.

Alternatively, UE1 determines to perform sidelink transmission in the sidelink burst, including transmission by at least one of the followings:
the UE transmits PSCCH on PSCCH resource, the PSCCH indicates control information of PSSCH on at least one PSSCH resource in the sidelink burst; in addition, the UE can also transmit a 2-stage SCI on the PSSCH resource, the 2-stage SCI indicates the control information of the PSSCH on the PSSCH resource and/or at least one PSSCH resource in the sidelink burst;
the UE transmits PSSCH to the same UE on one or multiple PSSCH resources; for example, UE1 transmits four PSSCH to UE2 on four PSSCH resources;
the UE transmits PSSCH to different UEs on multiple PSSCH resources; for example, UE1 transmits one PSSCH to UE2, UE3, UE4 and UE5 on four PSSCH resources respectively.

In the example, the above two ways can be combined, for example, UE transmits PSSCH to UE2 on the first and second data resources (that is, the first two data resources are used to transmit data to the same UE), and transmits PSSCH to UE3 and UE4 on the third and fourth data resources, respectively.

Alternatively, when the UE transmits the PSSCH to at most one UE on one or multiple PSSCH resources in the sidelink burst, the PSCCH in the sidelink burst (the PSCCH in the example can also be replaced by the 1-stage SCI and/or the 2-stage SCI, similarly hereinafter) indicates the destination identity (ID) of the at most one UE, and may also indicate the specific PSSCH resources used for sidelink transmission in the sidelink burst. Since there is no gap exceeding a specific length between sidelink transmissions in a sidelink burst, one method is to always use the first several PSSCH resources, so the PSCCH can only indicate the number of these PSSCH resources.

Alternatively, when UE transmits PSSCH to different UEs on multiple PSSCH resources, the PSCCH in the sidelink burst indicates the destination ID of the different UEs, and may also indicate the specific PSSCH resources used for sidelink transmission and/or the correspondence between the PSSCH resources and the UE destination ID in the sidelink burst. For example, since the sidelink burst includes four PSSCH resources, four destination IDs indicated in the PSCCH correspond to the four PSSCH resources in turn; wherein, if the UE transmits more than one PSSCH to one UE, its destination ID can be indicated more than once accordingly. The following example shows that there are four destination IDs indicated in the PSCCH, which are UE2, UE3, UE2 and UE4 in turn, then the four PSSCH resources in the sidelink burst are used to transmit PSSCH to UE2, UE3, UE2 and UE4 respectively in time domain order.

For another example, suppose that a sidelink burst is used for unicast/multicast communication within a UE group, the destination ID is indicated in the form of bitmap in PSCCH, the UE with index i in the group corresponds to the ith (or (i−1)th, (i+1)th, etc.) bit in the bitmap, and the multicast corresponds to a specific bit (such as the first or last bit) in the bitmap, and the bit marked with 1 in the bitmap indicates that the transmission corresponding to the bit is actually carried out. When multiple 1s are marked in the bitmap, the bits marked with 1 correspond to PSSCH resources in sequence. With specific examples, the following description is given: the bitmap' 1011100′ is indicated in PSCCH, wherein the first bit corresponds to multicast, and the next four bits correspond to UE with ID 1 to 6 in the group respectively; then the bitmap shows that the four PSSCH resources in the sidelink burst are used to transmit PSSCH to the UE group (i.e., multicast), UE2 (the abbreviation of UE with ID 2 in the group, hereinafter similar), UE3 and UE4 in time domain order respectively.

In the specific example, the UE determining the sidelink transmission resources includes determining to use at least one of the followings for HARQ-ACK feedback: using HARQ-ACK feedback bundling; using HARQ-ACK feedback based on sidelink codebook; and using independent HARQ-ACK feedback. Alternatively, to determine which way to use for HARQ-ACK feedback is based on the configuration and/or the number of PSFCH resources. Specifically, the sidelink burst contains N PSFCH resources, and alternatively, N=1 or N=4. Alternatively, when N=1, HARQ-ACK feedback bundling is used, that is, the one sidelink feedback resource is used for the receiving end UE to feed back 1-bit ACK/NACK data, and the 1-bit data corresponds to the HARQ-ACK results transmitted on all data resources in one sidelink burst. Alternatively, when N=1, the HARQ-ACK feedback based on the sidelink codebook is used, that is, the one sidelink feedback resource is used for the receiving end UE to feed back a sidelink codebook, in which the HARQ-ACK results of transmission on all data resources in a sidelink burst are indicated, for example, the codebook indicates a bitmap with a length of 4, which correspond to the ACK/NACK information of four sidelink data resources in one sidelink burst respectively. Alternatively, when N=4, independent HARQ-ACK feedback is used, that is, the four feedback resources correspond to the ACK/NACK information of four sidelink data resources in one sidelink burst respectively.

In other embodiments, one sidelink burst includes multiple sidelink control resources and multiple sidelink data resources, and may or may not include one or multiple sidelink feedback resources. The time domain length of each resource can be N slots and/or N symbols, where N is a positive integer, and different types of resources correspond to the same or different values of N. When UE determines the sidelink transmission resources, after determining the used sidelink burst, it is considered that all control and/or data resources in the sidelink burst can be used for the transmission of the UE; further, different resources in the sidelink burst can be used for the UE to transmit signals/channels to different or the same sidelink nodes.

In a specific example, UE1 determines to use the sidelink burst as shown in FIG. 6B to perform sidelink transmission. The sidelink burst contains four sidelink control resources (referred as PSCCH resources in the example), four sidelink data resources (referred as PSSCH resources in the example) and N sidelink feedback resources (referred as PSFCH resources in the example). Note that the number of PSCCH/PSSCH resources in the sidelink burst being four is only an example for the convenience of the following description, and can be similarly replaced with other values, which should not limit the protection scope. As shown in FIG. 6B, each PSCCH resource and PSSCH resource are FDM and TDM (here is only an example, or FDM only and TDM only, which will not be shown additionally), and all PSCCH and PSSCH resources and PSFCH resources are TDM. In the example, since the sidelink communication uses the 2-stage SCI mechanism, PSCCH resources are used to transmit the 1-stage SCI, and PSSCH resources can be used to transmit the 2-stage SCI; specifically, the UE can transmit the 2-stage SCI on each PSSCH resource.

Alternatively, UE1 determines to perform sidelink transmission in the sidelink burst, including: the UE independently performs transmission on each PSSCH resource and transmits the PSCCH associated with the PSSCH on the PSSCH and/or the corresponding PSCCH resource. Alternatively, if the UE transmits the PSSCH to the same UE on multiple consecutive PSSCH resources, the PSCCH is only transmitted on the PSCCH resource corresponding to the first PSSCH resource in the multiple consecutive PSSCH resources. Alternatively, the UE can also transmit a 2-stage SCI on each PSSCH resource, wherein the 2-stage SCI indicates the control information of the PSSCH on the PSSCH resource; alternatively, if the UE transmits the PSSCH to the same UE on multiple consecutive PSSCH resources, the 2-stage SCI is only transmitted on the first PSSCH resource on the plurality of consecutive PSSCH resources, wherein the 2-stage SCI indicates the control information of the PSSCH on the plurality of consecutive PSSCH resources.

Alternatively, when the UE transmits PSSCH to the same UE on multiple consecutive PSSCH resources in the sidelink burst, the PSCCH in the sidelink burst (the PSCCH in the example can also be replaced by the 1-stage SCI and/or the 2-stage SCI, similarly hereinafter) indicates the destination ID of the UE, and may also indicate the specific PSSCH resource used for sidelink transmission in the sidelink burst; for example, the number of consecutive PSSCH resources is indicated in the PSCCH.

In the specific example, the usage of the PSFCH resource is similar to that in the previous example, and the description will not be repeated.

In the existing sidelink communication system, the main reason why the last symbol in a slot is used as an gap is that the adjacent slots may be used by different UEs, there may be errors in the transmission timing of different UEs, and it takes some time for the UEs to switch between transmitting and receiving, so this gap can be used as a processing delay. In some embodiments, when the UE transmits the sidelink signal/channel using multiple continuous resources in a sidelink burst, no other gaps are used except that the last symbol of the last resource in the multiple resources can be used as a gap.

In some embodiments, the sidelink burst includes multiple PSSCH resources (and/or multiple PSCCH resources), and the UE determines the sidelink frame structure in the sidelink burst according to whether data can be transmitted to different UEs in the sidelink burst and/or the power control status of each PSSCH. Further, it includes determining the number/position of AGC symbols; since AGC symbols are not used for rate matching, generally speaking, rate matching starts from the first symbol after AGC symbols, and accordingly, the method can also be regarded as determining the position of rate matching.

Alternatively, if the UE uses M consecutive PSSCH resources to transmit data to the same destination UE, and the UE uses the same transmission power on the M PSSCH resources (the transmission power can be the total transmission power of PSCCH/PSSCH, such as the total transmission power of all signals/channels on one symbol), the first PSSCH resource in the M consecutive PSSCH resources and/or the first symbol of the associated PSCCH are used for AGC, that is, the first PSSCH resource in the M consecutive PSSCH resources and/or the associated PSCCH start rate matching from the second time unit (time unit such as symbol, slot, etc.); The remaining PSSCH resources in the M consecutive PSSCH resources and/or associated PSCCH do not contain AGC symbols, that is, the remaining PSSCH resources in the M consecutive PSSCH resources and/or associated PSCCH start rate matching from the first time unit. In other words, if the UE uses M consecutive PSSCH resources to transmit data to the same destination UE, and the UE uses the same transmission power on the M PSSCH resources (the transmission power can be the total transmission power of PSCCH/PSSCH, such as the total transmission power of all signals/channels on one symbol), the first PSSCH resource in the M consecutive PSSCH resources and/or the associated PSCCH are mapped from the second time unit, and the remaining PSSCH resources in the M consecutive PSSCH resources and/or the associated PSCCH are mapped from the first time unit, wherein the first symbol of the first PSSCH resource and/or the associated PSCCH can be used for automatic gain AGC.

Alternatively, if the UE uses M consecutive PSSCH resources to transmit data to different destination UEs, and the UE uses the same transmission power on the M PSSCH resources (the transmission power can be the total transmission power of all signals/channels on one symbol, such as the total transmission power of PSCCH/PSSCH), the first PSSCH resource in the M consecutive PSSCH resources and/or the first symbol of the associated PSCCH are used for AGC, that is, the first PSSCH resource in the M consecutive PSSCH resources and/or the associated PSCCH start rate matching from the second time unit (time unit such as symbol, slot, etc.); The remaining PSSCH resources in the M consecutive PSSCH resources and/or associated PSCCH do not include AGC symbols, that is, the remaining PSSCH resources in the M consecutive PSSCH resources and/or associated PSCCH start rate matching from the first time unit. In other words, if the UE uses M consecutive PSSCH resources to transmit data to different destination UEs, and the UEs use the same transmission power on the M PSSCH resources (the transmission power can be the total transmission power of all signals/channels on one symbol, such as the total transmission power of PSCCH/PSSCH), the first PSSCH resource in the M consecutive PSSCH resources and/or the associated PSCCH are mapped from the second time unit, and the remaining PSSCH resources in the M consecutive PSSCH resources and/or the associated PSCCH are mapped from the first time unit, wherein the first time unit of the first PSSCH resource and/or the associated PSCCH can be used for automatic gain AGC.

Alternatively, if the UE uses M consecutive PSSCH resources and/or corresponding PSCCH resources to transmit PSSCH and/or associated PSCCH to the same or different destination UEs, the UE adopts the same transmission power. Alternatively, if the UE uses M consecutive PSSCH resources and/or corresponding PSCCH resources to transmit PSSCH and/or associated PSCCH to the same or different destination UEs, the UE determines the transmission power based on the downlink loss (the transmission power can be the total transmission power of all signals/channels on one symbol, such as the total transmission power of PSCCH/PSSCH). Alternatively, if the transmitting end UE indicates in SCI that M consecutive PSSCH resources and/or corresponding PSCCH resources are used to transmit the PSSCH and/or the associated PSCCH, whether the transmission powers of the M PSSCH and/or the associated PSCCH are the same is indicated in SCI; accordingly, if the receiving end UE detects that the transmitting end UE indicates in SCI that M consecutive PSSCH resources and/or corresponding PSCCH resources are used to transmit PSSCH and/or associated PSCCH, if the transmitting end UE indicates in SCI that the transmission power of the M PSSCH and/or associated PSCCH is the same or based on downlink loss, the receiving end UE accordingly considers that only the first PSSCH and/or the associated PSCCH include AGC symbols, otherwise, if the transmitting end UE indicates in SCI that the transmission powers of the M PSSCHs and/or the associated PSCCHs are different or not based on downlink loss only, the receiving end UE accordingly considers that each PSSCH and/or the associated PSCCH include AGC symbols. The advantage of the method is that on the basis of reusing the existing technology to improve the forward compatibility, by adopting an appropriate method (selecting downlink path loss instead of sidelink path loss), the transmission power of the UE on consecutive resources is ensured to be unchanged, so that the UE does not need to reserve AGC symbols, and the resource utilization efficiency is improved.

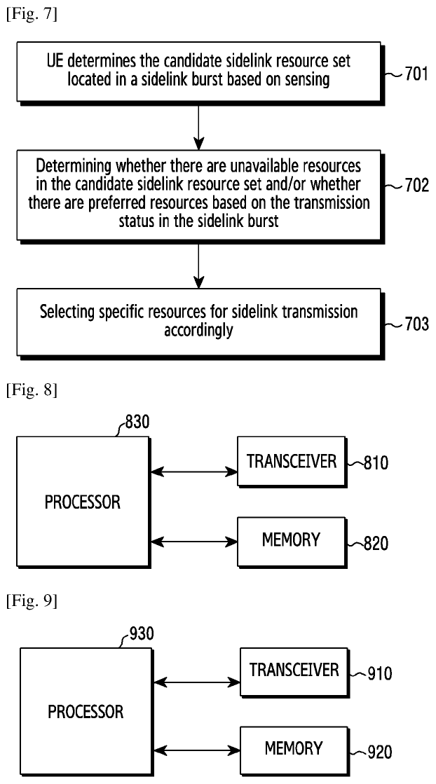

FIG. 7 schematically illustrates an embodiment according to the present disclosure.

In some embodiments, a sidelink burst includes multiple sidelink control resources and multiple sidelink data resources, and may or may not include one or multiple sidelink feedback resources; the time domain length of each resource can be N slots and/or N symbols, where N is a positive integer, and different types of resources correspond to the same or different values of N. When the UE determines the sidelink transmission resources, after determining the used sidelink burst, it further determines the specific resources that can be used for sidelink transmission in the sidelink burst, that is, compared with the embodiment 2, the sidelink transmission resources determined by the UE can be a subset of the resources in the sidelink burst instead of all the resources.

As shown in FIG. 7, the UE determines the sidelink transmission resources, including: the UE determines the candidate sidelink resource set located in a sidelink burst based on sensing (701), and determines whether there are unavailable resources in the candidate sidelink resource set and/or whether there are preferred resources based on the transmission status in the sidelink burst (702), and accordingly selects specific resources for sidelink transmission (703).

Alternatively, for any candidate resource in the candidate sidelink resource set, when no signal is detected within a time range exceeding a certain length before the candidate resource (the listening can be based on LBT), it is considered that the candidate resource is unavailable; it can also be considered that other resources later than the candidate resource are unavailable, that is, the sidelink burst is considered invalid. The specific length can be the threshold value of the gap length that may not exist in the sidelink burst, for example, 16 us.

Alternatively, for any candidate resource in the candidate sidelink resource set, when the adjacent sidelink resource before the candidate resource is reserved by other sidelink transmission (such as the resource reservation indicated in SCI) and/or a signal is detected on the adjacent sidelink resource before the candidate resource (the monitoring can be based on LBT), the candidate resource is preferentially selected for sidelink transmission.

Alternatively, for any candidate resource in the candidate sidelink resource set, when no signal is detected within a time range exceeding a certain length before the candidate resource, it is determined that the candidate resource is unavailable and/or that other resources later than the candidate resource are unavailable.

Alternatively, for any candidate resource in the candidate sidelink resource set, when no signal is detected within a time range exceeding a specific length before the candidate resource, instead of accordingly determining that the candidate resource is not available and/or that other resources later than the candidate resource are not available, it is determined that if the sidelink signal/channel is transmitted on the candidate resource, LBT with a specific length is required before the transmission.

The application provides a method for sidelink communication on a shared spectrum, so that the sidelink communication system can meet the restrictions of regulations on wireless communication in unlicensed frequency bands, and the utilization efficiency of wireless resources can be improved.

FIG. 8 schematically illustrates a base station according to various embodiments of the present disclosure.

As shown in FIG. 8, the base station according to an embodiment may include a transceiver 810, a memory 820, and a processor 830. The transceiver 810, the memory 820, and the processor 830 of the base station may operate according to a communication method of the base station described above. However, the components of the base station are not limited thereto. For example, the base station may include more or fewer components than those described above. In addition, the processor 830, the transceiver 810, and the memory 820 may be implemented as a single chip. Also, the processor 830 may include at least one processor.

The transceiver 810 collectively refers to a base station receiver and a base station transmitter, and may transmit/receive a signal to/from a terminal. The signal transmitted or received to or from the terminal may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the base station. Also, the memory 820 may store control information or data included in a signal obtained by the base station. The memory 820 may be a storage medium, such as read-only memory (ROM), random access memory (RAM), a hard disk, a CD-ROM, and a DVD, or a combination of storage media.

The processor 830 may control a series of processes such that the base station operates as described above. For example, the transceiver 810 may receive a data signal including a control signal transmitted by the terminal, and the processor 830 may determine a result of receiving the control signal and the data signal transmitted by the terminal.

FIG. 9 schematically illustrates a UE according to various embodiments of the present disclosure.

As shown in FIG. 9, the terminal of the present disclosure may include a transceiver 910, a memory 920, and a processor 930. The transceiver 910, the memory 920, and the processor 930 of the terminal may operate according to a communication method of the terminal described above. However, the components of the terminal are not limited thereto. For example, the terminal may include more or fewer components than those described above. In addition, the processor 930, the transceiver 910, and the memory 920 may be implemented as a single chip. Also, the processor 930 may include at least one processor.

The transceiver 910 collectively refers to a terminal receiver and a terminal transmitter, and may transmit/receive a signal to/from a base station. The signal transmitted or received to or from the base station may include control information and data. In this regard, the transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the terminal. Also, the memory 920 may store control information or data included in a signal obtained by the terminal. The memory 920 may be a storage medium, such as ROM, RAM, a hard disk, a CD-ROM, and a DVD, or a combination of storage media.

The processor 930 may control a series of processes such that the terminal operates as described above. For example, the transceiver 910 may receive a data signal including a control signal, and the processor 930 may determine a result of receiving the data signal.

The application also discloses an electronic device, comprising: a memory, which is configured to store a computer program; and a processor, which is configured to read the computer program from the memory and run the computer program to implement the above method.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential clement that must be included in the claims scope. The scope of patented subject matter is defined by the claims.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

A method for determining sidelink resource is provided. The method includes applying a sidelink communication system on a shared spectrum by a first node and determining a sidelink transmission resource based on the sidelink communication system being applied on the shared spectrum.

In an embodiment, applying of the sidelink communication system on the shared spectrum by the first node may include determining a relevant information of the sidelink resources in channel occupation time COT and/or a relevant information of the sidelink resources in a sidelink burst by the first node.

In an embodiment, determining of the relevant information of the sidelink resources in the channel occupation time and/or the relevant information of the sidelink resources in the sidelink burst by the first node may include determining at least one of the number, length and position of the gap in the COT and/or at least one of the number, length and position of the gap in the sidelink burst by the first node.

In an embodiment, the first node may determine at least one of the number, length and position of the gap in the COT and/or at least one of the number, length and position of the gap in the sidelink burst through pre-configured and/or base station-configured and/or other node-configured information and/or predetermined criteria.

In an embodiment, at least one of followings may be include in the sidelink burst: one or multiple sidelink control resources, one or multiple sidelink data resources, or one or multiple sidelink feedback resources.

In an embodiment, different resources in the sidelink burst may be used by the first node to transmit signals/channels to different or same sidelink node.

In an embodiment, determining of the sidelink transmission resource by the first node may include determining the used sidelink burst by the first node and determining to perform sidelink transmission in the sidelink burst.

In an embodiment, determining to perform sidelink transmission in the sidelink burst by the first node may include determining that all control and/or data resources in the sidelink burst can be used by the first node for transmission of control channels and/or data channels after determining the used sidelink burst.

In an embodiment, determining to perform sidelink transmission in the sidelink burst by the first node may include performing transmission through at least one of the first node transmits a physical sidelink control channel PSCCH on a sidelink control resource, the first node transmits a 2-stage sidelink control information SCI on a sidelink data resource, the first node transmits a physical sidelink shared channel PSSCH to the same node on one or multiple sidelink data resources and the first node transmits PSSCH to different nodes on multiple sidelink data resources.

In an embodiment, when transmitting the PSSCH to the same node on one or multiple sidelink data resources by the first node, the PSCCH or the 1-stage SCI and/or the 2-stage SCI in the sidelink burst may indicate the destination identity ID of the same node and/or indicate the sidelink data resources relevant information used for sidelink transmission in the sidelink burst.

In an embodiment, when transmitting the PSSCH to different nodes on multiple sidelink data resources by the first node, the PSCCH or the 1-stage SCI and/or the 2-stage SCI within the sidelink burst may indicate the destination ID of the different nodes, or indicate the sidelink data resource relevant information used for sidelink transmission and/or the correspondence between the sidelink data resources and the destination ID of the nodes in the sidelink burst.

In an embodiment, determining of the sidelink transmission resources by the first node may include determining to use at least one of the followings for HARQ-ACK feedback using HARQ-ACK feedback bundling, using sidelink codebook based HARQ-ACK feedback, or using independent HARQ-ACK feedback.

In an embodiment, determining of which way to use for HARQ-ACK feedback may be based on the configuration and/or the number of PSFCH resources.

In an embodiment, determining to perform sidelink transmission in the sidelink burst by the first node may include at least one of if the first node transmits a physical sidelink shared channel PSSCH to the same node on a plurality of continuous sidelink data resources, a physical sidelink control channel PSCCH is transmitted on a sidelink control resource corresponding to the first sidelink data resource in the plurality of continuous sidelink data resources, or if the first node transmits PSSCH to the same node on a plurality of continuous sidelink data resources, a 2-stage sidelink control information SCI is transmitted on the first sidelink data resource of the plurality of continuous sidelink data resources, and the 2-stage SCI indicates the control information of PSSCH on the plurality of continuous sidelink data resources. The PSCCH may indicate the number of the plurality of continuous sidelink data resources.

In an embodiment, determining to perform sidelink transmission in the sidelink burst by the first node may included if the first node uses M consecutive sidelink data resources to transmit data to the same or different destination nodes, and the first node uses the same transmission power on the M sidelink data resources, the first sidelink data resource and/or the associated sidelink control resources of the M consecutive sidelink data resources are mapped from the second time unit, and the remaining sidelink data resources and/or the associated sidelink control resources of the M consecutive sidelink data resources are mapped from the first time unit, wherein the first time unit of the first sidelink data resource and/or the associated sidelink control resources can be used for automatic gain control AGC.

In an embodiment, determining to perform sidelink transmission in the sidelink burst by the first node may include at least one of if the first node uses M consecutive sidelink data resources and/or corresponding sidelink control resources to transmit the physical sidelink shared channel PSSCH and/or the associated physical sidelink control channel PSCCH to the same or different destination nodes, the first node transmits the PSSCH and/or the associated PSCCH with the same transmission power, if the first node uses M consecutive sidelink data resources and/or corresponding sidelink control resources to transmit PSSCH and/or associated PSCCH to the same or different destination nodes, the first node determines the transmission power of PSSCH and/or associated PSCCH based on the downlink loss, or if the transmitting node indicates in SCI that M consecutive sidelink data resources and/or corresponding sidelink control resources are used to transmit PSSCH and/or associated PSCCH, it is indicated in SCI whether the transmission powers of the M PSSCH and/or the associated PSCCH are the same. The sidelink control resources may include PSCCH resources, and the sidelink data resources comprise PSSCH resources.

In an embodiment, determining the sidelink transmission resources by the first node may include determining candidate sidelink resource set located in the sidelink burst by the first node based on sensing, determining whether there are unavailable resources in the candidate sidelink resource set and/or whether there are preferentially selected resources based on the transmission status in the sidelink burst and selecting resources for sidelink transmission accordingly.

In an embodiment, determining whether there are unavailable resources in the candidate sidelink resource set may include when no signal is detected within a time range exceeding a specific length before the candidate resource, it is determined that the candidate resource is unavailable and/or that other resources later than the candidate resource are unavailable.

In an embodiment, determining whether there are preferentially selected resources in the candidate sidelink resource set may include when the adjacent sidelink resource prior to the candidate resource is reserved by other sidelink transmission and/or a signal is detected on the adjacent sidelink resource prior to the candidate resource, the candidate resource is preferentially selected for sidelink transmission.

A first node device is provided. The first node device includes a transceiver and a controller coupled with the transceiver and configured to apply a sidelink communication system on a shared spectrum by a first node and determine a sidelink transmission resource based on the sidelink communication system being applied on the shared spectrum.

The term “module” may indicate a unit including one of hardware, software, firmware, or a combination thereof. The term “module” can be used interchangeably with the terms “unit”, “logic”, “logic block”, “component” and “circuit”. The term “module” may indicate the smallest unit or part of an integrated component. The term “module” may indicate the smallest unit or part that performs one or more functions. The term “module” refers to a device that can be implemented mechanically or electronically. For example, the term “module” may indicate a device including at least one of an application specific integrated circuit (ASIC), a field programmable gate array (FPGA), or a programmable logic array (PLA) that performs certain operations, which are known or will be developed in the future.

According to an embodiment of the present disclosure, at least a part of a device (for example, a module or its function) or a method (for example, an operation) may be implemented as instructions stored in a non-transitory computer-readable storage medium, for example, in the form of a programming circuit. When run by a processor, instructions can enable the processor to perform corresponding functions. The non-transitory computer-readable storage medium may be, for example, a memory.

Non-transitory computer-readable storage media may include hardware devices such as hard disks, floppy disks, and magnetic tapes (for example, magnetic tapes), optical media such as compact disk read-only memory (ROM) (CD-ROM) and digital versatile disk (DVD), magneto-optical media such as optical disks, ROM, random access memory (RAM), flash memory, etc. Examples of program commands may include not only machine language codes, but also higher layer language codes that can be executed by various computing devices using an interpreter. The aforementioned hardware devices may be configured to operate as one or more software modules to perform the embodiments of the present disclosure, and vice versa.

The circuit or programming circuit according to various embodiments of the present disclosure may include at least one or more of the aforementioned components, omit some of them, or further include other additional components. Operations performed by the circuits, programming circuits, or other components according to various embodiments of the present disclosure may be performed sequentially, simultaneously, repeatedly, or heuristically. In addition, some operations may be performed in a different order, or omitted, or include other additional operations.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an clement expressed in a plural form may also be configured as a single element, and an element expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. Also, the embodiments may be combined with each other as required. For example, a base station and a terminal may operate with some of the methods proposed in the present disclosure combined together. Also, the embodiments are proposed based on a 5G or NR system, but other modifications based on technical ideas of the embodiments may be implemented on other systems, such as an LTE, LTE-A, LTE-A-Pro systems.

The embodiments of the present disclosure are described to facilitate understanding of the present disclosure, but are not intended to limit the scope of the present disclosure. Therefore, the scope of the present disclosure should be construed as including all changes or various embodiments based on the scope of the present disclosure defined by the appended claims and their equivalents.

1-15. (canceled)

16. A method performed by a User Equipment (UE) in a wireless communication system, the method comprising:
determining a gap for a sidelink transmission in a channel occupancy time (COT); and
performing a sidelink transmission in the COT based on the gap.

17. The method of claim 16, wherein the sidelink transmission is performed based on at least one sidelink resource in a sidelink burst.

18. The method of claim 17, wherein the at least one sidelink resource is related to at least one of a physical sidelink control channel (PSCCH), a physical sidelink shared channel (PSSCH) or a physical sidelink feedback channel (PSFCH).

19. The method of claim 16, wherein the determining of the gap for the sidelink transmission in the COT includes:
determining at least one of a number, a length, or a position of the gap for the sidelink transmission in the COT.

20. The method of claim 16, wherein the COT is shared with at least one of a base station or at least one other UE.

21. The method of claim 20, further comprising:
initializing the COT; and
transmitting, to the at least one of the base station or the at least one other UE, information on the COT.

22. The method of claim 20, further comprising:
receiving, from the at least one of the base station or the at least one other UE, information on the COT.

23. A User Equipment (UE) in a wireless communication system, the UE comprising:
a transceiver; and
a controller coupled with the transceiver and configured to:
determine a gap for a sidelink transmission in a channel occupancy time (COT), and
perform a sidelink transmission in the COT based on the gap.

24. The UE of claim 23, wherein the sidelink transmission is performed based on at least one sidelink resource in a sidelink burst.

25. The UE of claim 24, wherein the at least one sidelink resource is related to at least one of a physical sidelink control channel (PSCCH), a physical sidelink shared channel (PSSCH) or a physical sidelink feedback channel (PSFCH).

26. The UE of claim 23, wherein the controller is configured to:
determine at least one of a number, a length, or a position of the gap for the sidelink transmission in the COT.

27. The UE of claim 23, wherein the COT is shared with at least one of a base station or at least one other UE.

28. The UE of claim 23, wherein the controller is further configured to:
initialize the COT; and
transmit, to at least one of a base station or at least one other UE, information on the COT.

29. The UE of claim 23, wherein the controller is further configured to:
receive, from at least one of a base station or at least one other UE, information on the COT.
